(19) United States
(12) Patent Application Publication
(10) Pub. No.: US 2019/0238812 A1
(43) Pub. Date: Aug. 1, 2019

(54) IMAGE PROCESSING APPARATUS, IMAGE CAPTURING APPARATUS, AND IMAGE PROCESSING METHOD

(71) Applicant: CANON KABUSHIKI KAISHA, Tokyo (JP)

(72) Inventor: Daisuke Wakamiya, London (GB)

(21) Appl. No.: 16/256,150

(22) Filed: Jan. 24, 2019

(30) Foreign Application Priority Data
Jan. 29, 2018 (JP) 2018-012946

(51) Int. Cl. H04N 9/64; H04N 5/232; H04N 9/80

(52) U.S. Cl. CPC H04N 9/64; H04N 9/80; H04N 5/23241; H04N 5/23245

(57) ABSTRACT

There is provided an image processing apparatus. A memory includes a first storage area and a second storage area. A transfer unit transfers a first LUT to the first storage area and transfers a second LUT to the second storage area. An image processing unit alternately uses the first LUT and the second LUT stored in the memory to sequentially perform an image process on a plurality of images. The transfer unit updates the first LUT within a period from a time when the first LUT is used by the image processing unit to a time when the first LUT is used for the next time and updates the second LUT within a period from a time when the second LUT is used by the image processing unit to a time when the second LUT is used for the next time.

### BACKGROUND OF THE INVENTION

### Field of the Invention

The present invention relates to an image processing apparatus, an image capturing apparatus, and an image processing method.

### Description of the Related Art

In some cases, an image capturing apparatus such as a digital camera performs conversion in a color phase, color saturation, a color gamut, gamma, and the like into a level suitable for each image capturing mode. As a method of such conversion, a method utilizing a three-dimensional look-up table (3DLUT) is known (3DLUT conversion). In the 3DLUT conversion, for example, representative conversion parameters of three colors R, G, and B are prepared as table data, and pixel values between representative points (grid points) are obtained by an interpolation process.

In order to perform an image process at high speed, in general, the table data for the 3DLUT conversion is implemented capable of being accessed from a high-speed memory such as a SRAM. Thus, control may be performed with a flow in which the image process is performed by developing the table data stored in the ROM in a temporary storage area such as a DRAM, performing processing such as color conversion depending on a use case, and then transferring the data to the SRAM. In most cases, the process of transferring the table data to the SRAM is performed during a time period when the image process is not performed, such as immediately after mode switching and during a blanking period of a moving image.

The 3DLUT conversion is used for various purposes. For example, the 3DLUT conversion is used in order to dynamically control brightness, a color phase, and the like in accordance with an image capturing mode or a scene situation. Further, as another usage of the 3DLUT conversion, the 3DLUT conversion is used in order to adjust a dynamic range and a color gamut in accordance with a recording method and a display device. In some cases, table data fixed for each mode to some extent is used.

It is preferred that the number of grids of a look-up table (LUT) be large to perform the image process at high accuracy, however, increasing the number of grids causes a circuit scale to exponentially increase. In the 3 DLUT with m grids, the number of grids for one dimension is m. Thus, the total number of grids is m³. For example, a memory capacity required for 33-grid, 16-bit, and RGB is 215622 bites obtained by 33×33×33×3×2. Thus, there have been desired a configuration of a memory, which achieves a highly accurate 3DLUT conversion with a suppressed circuit scale, and control (control including storage and transfer of an LUT). For example, in Japanese Patent Laid-Open No. 2012-149150, there is proposed a method of storing a plurality of LUTs in an external memory, selecting a necessary LUT, and transferring and storing the LUT in a table memory.

As described above, the 3DLUT conversion is used for various purposes. Thus, in some cases, calculation accuracy and update frequency which are required are different depending on use cases. For example, in a case where a consumer camera automatically adjusts brightness, a color phase, and the like in accordance with an image capturing scene, a table is required to be updated for each frame. However, in order to improve display delay and achieve smooth image display, recording and display with a high frame rate have recently been demanded. Accordingly, a blanking period tends to be reduced due to an increased frame rate. Therefore, with a configuration in Japanese Patent Laid-Open No. 2012-149150, when the LUT is updated for each frame, a sufficient transfer period may not be secured.

### SUMMARY OF THE INVENTION

The present invention has been made in view of the above, and provides a technique capable of suppressing increase of a circuit scale and frequently updating an LUT to be used.

According to a first aspect of the present invention, there is provided an image processing apparatus comprising: a memory including a first storage area and a second storage area; and at least one processor and/or circuit configured to function as following units: a transfer unit configured to transfer a first LUT to the first storage area and transfer a second LUT to the second storage area; and an image processing unit configured to alternately use the first LUT and the second LUT stored in the memory to sequentially perform an image process on a plurality of images, wherein the transfer unit updates the first LUT within a period from a time when the first LUT is used by the image processing unit to a time when the first LUT is used for the next time and updates the second LUT within a period from a time when the second LUT is used by the image processing unit to a time when the second LUT is used for the next time.

According to a second aspect of the present invention, there is provided an image capturing apparatus comprising: the image processing apparatus according to the first aspect; and an image sensor configured to generate a moving image including the plurality of images.

According to a third aspect of the present invention, there is provided an image processing apparatus comprising: a memory including a plurality of storage areas; and at least one processor and/or circuit configured to function as following units: a transfer unit configured to transfer an LUT to each of the plurality of storage areas; and an image processing unit configured to use the LUT stored in any of the plurality of storage areas to sequentially perform an image process on the plurality of images, the image processing unit using LUTs stored in different storage areas with respect to two images to be sequentially processed, wherein with respect to each of the plurality of storage areas, the transfer unit updates the LUT stored in the storage area within a period from a time when the LUT stored in the storage area is used by the image processing unit to a time when the LUT is used for the next time.

According to a fourth aspect of the present invention, there is provided an image processing method executed by an image processing apparatus having a memory including a first storage area and a second storage area, the method comprising: transferring a first LUT to the first storage area and transferring a second LUT to the second storage area; alternately using the first LUT and the second LUT stored in the memory to sequentially perform an image process on a plurality of images; and updating the first LUT within a period from a time when the first LUT is used for the image process to a time when the first LUT is used for the next time and updating the second LUT within a period from a time when the second LUT is used for the image process to a time when the second LUT is used for the next time.

According to a fifth aspect of the present invention, there is provided an image processing method executed by an image processing apparatus having a memory including a plurality of storage areas, the method comprising: transferring an LUT to each of the plurality of storage areas; using the LUT stored in any of the plurality of storage areas to sequentially perform an image process on the plurality of images, wherein LUTs stored in different storage areas are used with respect to two images to be sequentially processed; and with respect to each of the plurality of storage areas, updating the LUT stored in the storage area within a period from a time when the LUT stored in the storage area is used for the image process to a time when the LUT is used for the next time.

Further features of the present invention will become apparent from the following description of exemplary embodiments with reference to the attached drawings.

### BRIEF DESCRIPTION OF THE DRAWINGS

FIG. 1 is a block diagram illustrating a configuration of a digital camera 100.

FIG. 2 is a diagram for describing an outline of a process of a 3DLUT conversion unit 106.

FIG. 3 is a diagram for describing the 3DLUT conversion unit 106 in detail.

FIG. 4 is a diagram for describing control timing of an LUT fixed mode.

FIG. 5 is a diagram for describing control timing of an LUT switch mode.

FIG. 6 is a diagram for describing control timing in a case where only a lower memory unit side of a memory 305 is used in the LUT switch mode.

### DESCRIPTION OF THE EMBODIMENTS

Hereinafter, embodiments of the present invention will be described with reference to the attached drawings. Elements that are given the same reference numerals throughout all of the attached drawings represent the same or similar elements. Note that the technical scope of the present invention is defined by the claims, and is not limited by the following respective embodiments. Also, not all of the combinations of the aspects that are described in the embodiments are necessarily essential to the present invention. Also, the aspects that are described in the individual embodiments can be combined as appropriate.

### First Embodiment

In a first embodiment, description is made of an image capturing apparatus including an image processing apparatus. Further, in the following description, it is assumed that the image capturing apparatus is a digital camera. However, the image capturing apparatus according to this embodiment is not limited to a digital camera, and may be, for example, a digital video camera, a smartphone, a camera-equipped portable telephone, and an onboard camera.

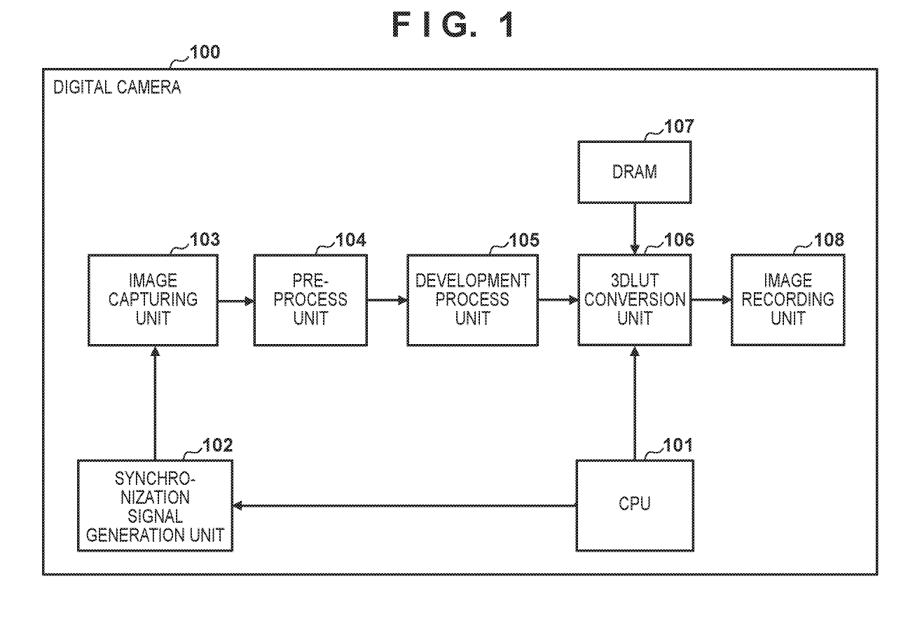

FIG. 1 is a block diagram illustrating a configuration of a digital camera 100 according to the first embodiment. In FIG. 1, a CPU 101 controls each unit of the digital camera 100 and an image capturing mode. The CPU 101 controls a synchronization signal generation unit 102 to start an operation of the synchronization signal generation unit 102. The synchronization signal generation unit 102 generates a synchronization signal for determining a fame rate in a case of a moving image, and transmits the synchronization signal to an image capturing unit 103. The frame rate is a constant rate determined with a standard, for example, 30 fps and 60 fps. In a case of a still image, a synchronization signal is generated in synchronization with an operation of a shutter button (not illustrated). On image data captured by the image capturing unit 103, various sensor correction processes, a defective pixel correction, and the like are applied by a pre-process unit 104, and a development process is applied by a development process unit 105. The image data captured by the image capturing unit 103 corresponds to a Bayer format image obtained through color filters of R (red), G (green), and B (blue). The image data with YCbCr, which is synchronized and separated depending on luminance and color difference by the development process and is suitable for a recording format, is output. On the output data of the development process unit 105, 3DLUT conversion is applied by a 3DLUT conversion unit 106. The CPU 101 transfer look-up table data from a DRAM 107 to the 3DLUT conversion unit 106 for the 3DLUT conversion. The output of the 3DLUT conversion unit 106 is recorded by an image recording unit 108.

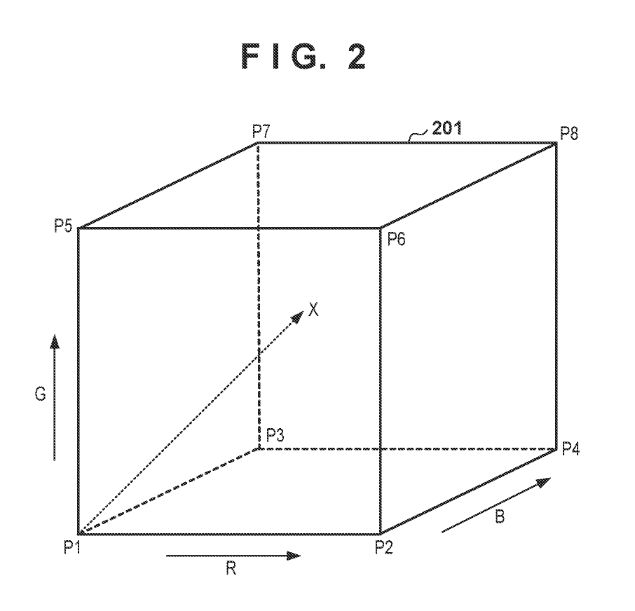

Next, with reference to FIG. 2, description is made of an outline of a process of the 3DLUT conversion unit 106. In the present embodiment, an LUT having nine grids is used. In this case, the number of grid points is 729 obtained by 9×9×9. A focus position of grid point 201 indicates a position of a grid point to be focused on the LUT, and three-dimensional directions are indicated with an R direction, a G direction, and a B direction. Reference symbols P1 to P8 indicate output data (output values) of grid points, and each grid point has values of R, G, and B. Here, output data of a position X in the focus position of grid point 201 can be calculated by performing the interpolation process corresponding to distances to the output data of the grid points P1 to P8. That is, when weight coefficients corresponding to the grid points P1 to P8 are expressed by W1 to W8, respectively, X can be obtained by the following equation.

X=P1×W1+P2×W2+P3×W3+P4×W4+P5×W5+P6×W6+P7×W7+P8×W8

Note that, for easy understanding of the description, a case where both the input and output data contain RGB signals is described. However, in the present embodiment, the input data contains RGB signals, and the output data contains YCbCr signals in association with a format of a recorded image. In this case, coefficients of the table are set so that the RGB signals are converted to the YCbCr signals in the LUT. As another example, both the input and output data of the LUT may be YCbCr signals.

Further, in the present embodiment, in order to perform the interpolation process for the 3DLUT conversion, the distances from the eight grid points are used as the weight coefficients. However, the interpolation method is not limited thereto, and any publicly known interpolation method such as the nearest neighbor method and the tetrahedral interpolation method may be used.

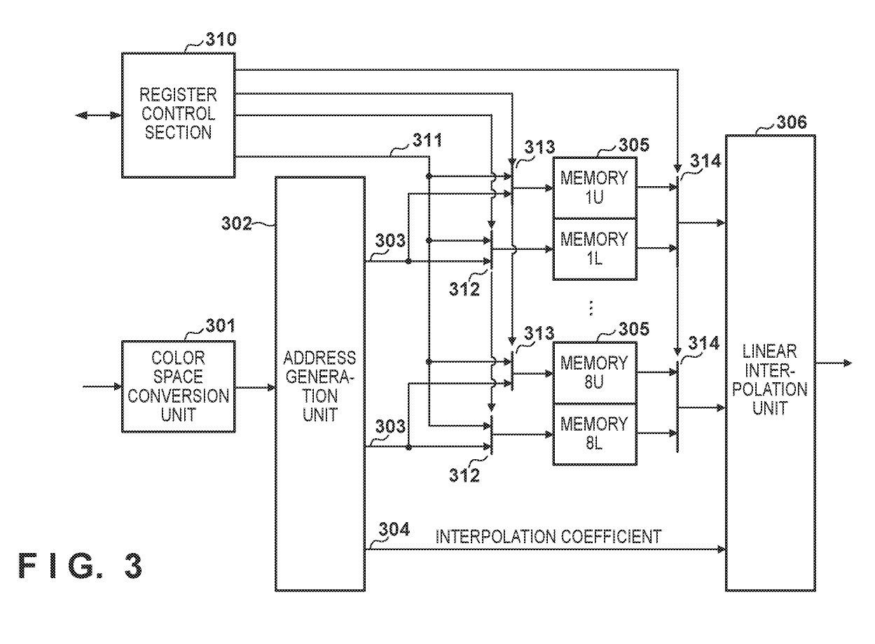

Next, with reference to FIG. 3, detail description is made of the 3DLUT conversion unit 106. A color space conversion unit 301 converts the input image data from the YCbCr signals to the RGB signals. The conversion is performed by, for example, 3×3 matrix calculation. Next, an address generation unit 302 generates an image process memory control signal 303 and an interpolation coefficient 304 based on the image data (RGB data) after conversion. The image process memory control signal 303 includes an address of the LUT and a read control signal. The read control signal always has a value for instructing reading during the image process period. The interpolation coefficient 304 corresponds to the above-mentioned weight coefficients W1 to W8.

For example, the address generation unit 302 uses high-order bits of the RGB data as the address of the image process memory control signal 303, and uses low-order bits as the interpolation coefficient 304. For example, when the RGB data contains 10 bits for each of R, G, and B, the address generation unit 302 can use the high-order three bits as the address of the image process memory control signal 303, and the remaining low-order seven bits as the interpolation coefficient 304.

A memory 305 includes eight memory units 1U to 8U and eight memory units 1L to 8L. Thus, the memory 305 includes sixteen memory units in total. Here, “U” indicates “Upper,” and “L” indicates “Lower.” The 3DLUT conversion unit 106 includes two conversion modes (operation modes), which are an LUT fixed mode and an LUT switch mode. In a case of the LUT fixed mode, the entire sixteen memory units 1U to 8U and 1L to 8L store one LUT. In this case, the addresses of the upper memories and the lower memories are associated, and the pair of the upper memories and the lower memories is regarded as one extended memory unit. In a case of the LUT switch mode, the eight memory units 1U to 8U store one LUT, and the eight memory units 1L to 8L store one LUT. Therefore, in the case of the LUT switch mode, the memory 305 store the two LUTs in total. The LUTs in the LUT switch mode are formed so that the number of grid points is equal to or smaller than a half of that in the LUT in the LUT fixed mode. For example, the number of grid points in the LUT fixed mode is 729 obtained by 9×9×9, and the number of grid points in the LUT switch mode is 343 obtained by 7×7×7. In another example, the number of grid points in the LUT fixed mode is 4913 obtained by 17×17×17, and the number of grid points in the LUT switch mode is 729 obtained by 9×9×9.

The access to the memory 305 (the output of the grid point data from the memory 305) is performed in accordance with the address of the image process memory control signal 303. Regardless of the value of the RGB data (that is, regardless of an absolute position of the focus position of grid point 201 in the LUT), the grid point data of the LUT is arranged so that all the grid points P1 to P8 can be obtained with one access to the memory 305. In the case of the LUT fixed mode, one of the grid points P1 to P8 is obtained from the memory unit 1U or 1L. Similarly, from each of the memory unit 2U or 2L, the memory unit 3U or 3L, . . . , and the memory unit 8U or 8L, one of the grid points P1 to P8 is obtained. As a whole, all the grid points P1 to P8 are obtained. In the case of the LUT switch mode, regarding the LUT stored in the memory units 1U to 8U, one of the grid points P1 to P8 is obtained for each of the memory units 1U to 8U, and as a whole, all the grid points P1 to P8 are obtained. Similarly, regarding the LUT stored in the memory units 1L to 8L, one of the grid points P1 to P8 is obtained for each the memory units 1L to 8L, and as a whole, all the grid points P1 to P8 are obtained. A method of arranging the grid point data so that all the grid points P1 to P8 are obtained with one access to the memory 305 in this way is not particularly limited to a specific method, but for example, any publicly known method such as an arrangement method in an increment order of address may be used.

In the present embodiment, the number of arrayed lower memory units is set to a power of two. In this case, when the highest-order bit of the address of the image process memory control signal 303 is 1, the address is on the upper memory side, and when the highest-order bit of the address thereof is 0, the address is on the lower memory side. With this configuration, an access destination selected from the upper memory units and the lower memory units can be determined with the highest-order bit. Thus, with a simple configuration, a memory extended function in which the upper memory units and the lower memory units are associated with each other can be implemented. Thus, the access involving the two memory units 1L and 1U of the memory 305 can be achieved.

A linear interpolation unit 306 performs the interpolation process described with reference to FIG. 2 based on the grid points P1 to P8 being the grid point data, which is output from the memory 305, and the interpolation coefficient 304, and outputs an interpolated YCbCr signal.

A register control unit 310 receives a command from the CPU 101, controls the 3DLUT conversion unit 106, and transfers the LUT from the DRAM 107 to the memory 305. The register control unit 310 outputs a CPU memory control signal 311. The CPU memory control signal 311 is used in order to control the memory 305 via the CPU 101, and includes an address of the memory 305, data, and a memory control signal indicating reading/writing. With the CPU memory control signal 311, the register control unit 310 can perform reading/writing to the memory 305 via the CPU 101.

The 3DLUT conversion unit 106 includes a lower memory selector 312, an upper memory selector 313, and a memory output selector 314. Those selectors are controlled by the register control unit 310. The lower memory selector 312 and the upper memory selector 313 select any one of the control by the CPU 101 or the image process control as the control of the memory 305. That is, the lower memory selector 312 and the upper memory selector 313 controls a signal, which is selected from the CPU memory control signal 311 and the image process memory control signal 303, to be connected to the memory 305. The memory output selector 314 selects any one of the upper memory units and the lower memory units of the memory 305 to be output.

The register control unit 310 appropriately controls the lower memory selector 312, the upper memory selector 313, and the memory output selector 314. In this manner, the LUT can be switched and updated depending on a use case. The updating timing may be directly controlled by the CPU 101, or may be synchronized with a synchronization signal generated by the synchronization signal generation unit 102.

Now, detail description is further made of the case where the LUT is fixed and used (the LUT fixed mode). In this case, before the image process is started, the CPU 101 sets the LUT in the 3DLUT conversion unit 106 in advance. During the image process, the 3DLUT conversion unit 106 performs the 3DLUT conversion through use of the same LUT (the grid point data). At this time, the memory 305 is used as one extended memory unit in which the upper memory units and the lower memory units are associated with each other. Specifically, with the highest-order bit of the address of the CPU memory control signal 311 or the image process memory control signal 303, the access is switched between the upper memory units and the lower memory units. Similarly, the memory output selector 314 switches the memory units to be used between the upper memory units and the lower memory units of the memory 305.

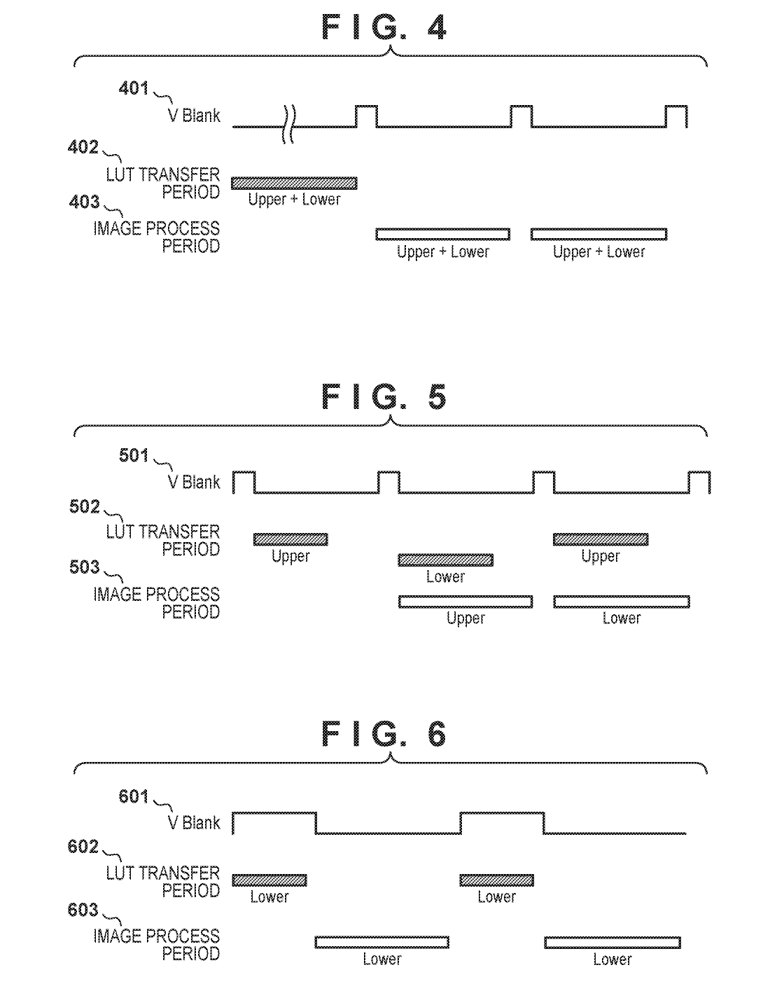

With reference to FIG. 4, description is made of the control timing of the LUT fixed mode. A reference symbol 401 indicates a V blanking signal issued from the synchronization signal generation unit 102. The V blanking signal 401 being high indicates a V blanking period. During this period, a preparation or a reset operation for processing a next frame is performed. The V blanking signal 401 being low indicates a video period. During this period, the image process is performed. A reference symbol 402 indicates a LUT transfer period, and a reference symbol 403 indicates an image process period. Further, “Upper+Lower” is illustrated to the LUT transfer period 402 and the image process period 403 to indicate that the target LUT is stored in an area involving the upper memory unit side and the lower memory unit side (extended area).

As illustrated in FIG. 4, first, the CPU 101 transfers the LUT to the memory 305 during the LUT transfer period 402, and the LUT is stored so that both the upper memory units and the lower memory units are involved. After that, the V blanking signal 401 varies to start the video period. During the video period, the 3DLUT conversion unit 106 performs the 3DLUT conversion through use of the same LUT throughout the period.

Next, description is made of the case where the LUT is updated for each frame to perform the 3DLUT conversion (the LUT switch mode). FIG. 5 is a diagram for illustrating the control timing of the LUT switch mode. Similarly to FIG. 4, a reference symbol 501 indicates a V blanking signal, a reference symbol 502 indicates a LUT transfer period, and a reference symbol 503 indicates an image process period. Further, “Upper” or “Lower” is illustrated to the LUT transfer period 502 and the image process period 503 to indicate that the target LUT to be transferred or to be used is stored in any of the upper memory unit side and the lower memory unit side (storage area).

Unlike the case in FIG. 4, in FIG. 5, the LUT transfer is started in synchronization with synchronization signal generated by the synchronization signal generation unit 102. In the first frame, the CPU 101 transfers the LUT to the upper memory unit side of the memory 305. In the next frame, the CPU 101 transfers the LUT to the lower memory unit side, and simultaneously, the 3DLUT conversion unit 106 uses the LUT stored in the upper memory unit side to perform the image process. In further next frame, in contrast, the CPU 101 transfers the LUT to the upper memory unit side, and simultaneously, the 3DLUT conversion unit 106 uses the LUT stored in the lower memory unit side to perform the image process.

In the case of the LUT fixed mode illustrated in FIG. 4, the upper memory units and the lower memory units of the memory 305 are associated to each other and used. In this manner, the number of grid points can be increased. Meanwhile, in the case of the LUT switch mode illustrated in FIG. 5, the LUT transfer and the image process are alternately switched between the upper memory units and the lower memory units. In this manner, the simultaneous processes can be performed. As described above, the LUT in the LUT switch mode is formed so that the number of grid points is equal to or smaller than a half of that in the LUT in the LUT fixed mode. Therefore, in the case of the LUT switch mode, the process can be performed only with the upper memory units or the lower memory units.

As described above, according to the first embodiment, the digital camera 100 sequentially performs the 3DLUT conversion (the image process) on the plurality of images included in the moving image. In the case of the LUT switch mode, the digital camera 100 alternately uses the LUT stored in the upper memory unit side and the LUT stored in the lower memory unit side in the memory 305. The digital camera 100 updates the LUT on the upper memory unit side within a period from the time when the LUT on the upper memory unit side is used for the image process to the time when the LUT on the upper memory unit side is used for the next time (that is, a period in which the LUT on the upper memory unit side is not used for the image process). Further, the digital camera 100 updates the LUT on the lower memory unit side within a period from the time when the LUT on the lower memory unit side is used for the image process to the time when the LUT on the lower memory unit side is used for the next time (that is, a period in which the LUT on the lower memory unit side is not used for the image process). With this, increase of the circuit scale can suppressed, and the LUT to be used can be updated frequently.

Further, in the case of the LUT fixed mode, the digital camera 100 transfers the LUT, which has grid points larger in number than that in the LUT switch mode, to the area including the upper memory unit side and the lower memory unit side of the memory 305 (extended area). Further, on the plurality of images included in the moving image, the image process is performed by using the LUT with the grid points larger in number than the grid points in the LUT switch mode. With this, accuracy of the image process can be improved. The digital camera 100 can select any one of the LUT switch mode and the LUT fixed mode, based on an instruction of a user or a use case. For example, a business-use camera uses the 3DLUT conversion to adjust a dynamic range and a color gamut in accordance with a recording method and a display device. Thus, the table is not necessarily required to be updated for each frame. On the contrary, in order to perform the image process at high accuracy, it is demanded that the number of grids be increased as many as possible. The LUT fixed mode is effective in such a case.

Note that, in the above description, the memory 305 is divided into two portions (storage areas), i.e., the upper memory unit side and the lower memory unit side. However, in the present embodiment, the number of divisions of the memory 305 is not limited to two, and any number of storage areas may be included in the memory 305. In this case, the digital camera 100 sequentially performs the image process on the plurality of images through use of the LUT stored in any of the plurality of storage areas. At this time, the digital camera 100 uses the LUTs stored in different storage areas with respect to the two images to be sequentially processed. Further, for each of the plurality of storage areas, the digital camera 100 updates the LUT stored in the storage area within a period from the time when the LUT is used for the image process to the time when the LUT is used for the next time.

### Second Embodiment

In the first embodiment, description is made of the configuration in which the LUT is updated (transferred) during the video period in the LUT switch mode. In a second embodiment, description is made of a configuration in which the LUT is updated during the V blanking period. In the second embodiment, the basic configuration of the digital camera 100 is similar to that in the first embodiment (see FIG. 1). Now, matters different from the first embodiment are mainly described.

In the case of the LUT switch mode, the digital camera 100 determines whether the LUT can be updated during the V blanking period (period in which the image process is not performed between the two successive timings among the periodic image process timings). When the LUT can be updated, the digital camera 100 updates the LUT during the V blanking period. In this case, the digital camera 100 can switch the LUT by using only one of the upper memory unit and the lower memory unit of the memory 305. At this time, the digital camera 100 turns off the power of the memory unit of the memory 305, which is not used (controls power supply to be stopped). With this, power consumption can be reduced.

FIG. 6 is a diagram for illustrating control timing in a case where only the lower memory unit side of the memory 305 is used in the LUT switch mode. Similarly to FIG. 5, a reference symbol 601 indicates a V blanking signal, a reference symbol 602 indicates a LUT transfer period, and a reference symbol 603 indicates an image process period. Further, “Lower” is illustrated to the LUT transfer period 602 and the image process period 603 to indicate that the target LUT is stored in the area (storage area) on the lower memory unit side.

Whether the LUT transfer can be performed during the V blanking period depends on various factors such as the number of grid points of the LUT, a frame rate, and a CPU performance. Therefore, for example, in a case where power saving is prioritized to accuracy of the 3DLUT conversion, the CPU 101 may perform control to use the LUT having a small number of grid points and transfer the LUT to only one of the upper memory unit side and the lower memory unit side during the V blanking period. In this case, the CPU 101 may turn off the power of any one of the upper memory unit side and the lower memory unit side, to which the LUT is not transferred. With this, power consumption can be reduced.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-012946, filed Jan. 29, 2018, which is hereby incorporated by reference herein in its entirety.

What is claimed is:

1. An image processing apparatus comprising:
a memory including a first storage area and a second storage area; and
at least one processor and/or circuit configured to function as following units:
a transfer unit configured to transfer a first LUT to the first storage area and transfer a second LUT to the second storage area; and
an image processing unit configured to alternately use the first LUT and the second LUT stored in the memory to sequentially perform an image process on a plurality of images,
wherein the transfer unit updates the first LUT within a period from a time when the first LUT is used by the image processing unit to a time when the first LUT is used for the next time and updates the second LUT within a period from a time when the second LUT is used by the image processing unit to a time when the second LUT is used for the next time.

2. The image processing apparatus according to claim 1, wherein
the at least one processor and/or circuit is further configured to function as a selection unit configured to select a first operation mode or a second operation mode,
in a case where the first operation mode is selected:
the transfer unit transfers the first LUT to the first storage area and transfers the second LUT to the second storage area;
the image processing unit alternately uses the first LUT and the second LUT stored in the memory to sequentially perform the image process on the plurality of images; and
the transfer unit updates the first LUT within the period from the time when the first LUT is used by the image processing unit to the time when the first LUT is used for the next time and updates the second LUT within the period from the time when the second LUT is used by the image processing unit to the time when the second LUT is used for the next time, and
in a case where the second operation mode is selected:
the transfer unit transfers a third LUT with grid points larger in number than grid points of the first LUT and the second LUT, to an extended area including the first storage area and the second storage area; and
the image processing unit uses the third LUT to sequentially perform an image process on the plurality of images.

3. The image processing apparatus according to claim 1, wherein
the image processing unit performs the image process at periodic timings,
the at least one processor and/or circuit is further configured to function as a determination unit configured to determine whether or not the transfer unit can update the first LUT during a period in which the image process is not performed between two successive timings of the periodic timings,
in a case where the first LUT cannot be updated during the period in which the image process is not performed:
the transfer unit transfers the first LUT to the first storage area and transfers the second LUT to the second storage area;
the image processing unit alternately uses the first LUT and the second LUT stored in the memory to sequentially perform the image process on the plurality of images; and
the transfer unit updates the first LUT within the period from the time when the first LUT is used by the image processing unit to the time when the first LUT is used for the next time and updates the second LUT within the period from the time when the second LUT is used by the image processing unit to the time when the second LUT is used for the next time, and
in a case where the first LUT can be updated during the period in which the image process is not performed:
the image processing unit uses the first LUT to sequentially perform the image process on the plurality of images; and
the transfer unit updates the first LUT during the period in which the image process is not performed.

4. The image processing apparatus according to claim 3, wherein the at least one processor and/or circuit is further configured to function as a control unit configured to control to stop power supply to the second storage area in a case where the first LUT can be updated during the period in which the image process is not performed.

5. An image capturing apparatus comprising:
the image processing apparatus according to claim 1; and
an image sensor configured to generate a moving image including the plurality of images.

6. An image processing apparatus comprising:
a memory including a plurality of storage areas; and
at least one processor and/or circuit configured to function as following units:
a transfer unit configured to transfer an LUT to each of the plurality of storage areas; and
an image processing unit configured to use the LUT stored in any of the plurality of storage areas to sequentially perform an image process on the plurality of images, the image processing unit using LUTs stored in different storage areas with respect to two images to be sequentially processed,
wherein with respect to each of the plurality of storage areas, the transfer unit updates the LUT stored in the storage area within a period from a time when the LUT stored in the storage area is used by the image processing unit to a time when the LUT is used for the next time.

7. An image processing method executed by an image processing apparatus having a memory including a first storage area and a second storage area, the method comprising:
transferring a first LUT to the first storage area and transferring a second LUT to the second storage area;
alternately using the first LUT and the second LUT stored in the memory to sequentially perform an image process on a plurality of images; and
updating the first LUT within a period from a time when the first LUT is used for the image process to a time when the first LUT is used for the next time and updating the second LUT within a period from a time when the second LUT is used for the image process to a time when the second LUT is used for the next time.

8. An image processing method executed by an image processing apparatus having a memory including a plurality of storage areas, the method comprising:
transferring an LUT to each of the plurality of storage areas;
using the LUT stored in any of the plurality of storage areas to sequentially perform an image process on the plurality of images, wherein LUTs stored in different storage areas are used with respect to two images to be sequentially processed; and
with respect to each of the plurality of storage areas, updating the LUT stored in the storage area within a period from a time when the LUT stored in the storage area is used for the image process to a time when the LUT is used for the next time.
